(19) United States
(12) Patent Application Publication
(10) Pub. No.: US 2007/0217008 A1
(43) Pub. Date: Sep. 20, 2007

(54) Polarizer films and methods of making the same

(76) Inventors: Jian Jim Wang, Orefield, PA (US); Greg E. Blonder, Summit, NJ (US)

Correspondence Address: FISH & RICHARDSON PC, P.O. BOX 1022, MINNEAPOLIS, MN, 55440-1022, US

(21) Appl. No.: 11/378,230

(22) Filed: Mar. 17, 2006

(51) Int. Cl. G02B 5/30

(52) U.S. Cl. 359/486; 359/483

(57) ABSTRACT

In general, in one aspect, the invention features methods that include forming a roll of a first material into a substrate and forming a plurality of rows of a second material on the substrate, where the second material includes a metal, the rows of the second material extend along a first direction, the rows are spaced apart from one another, and adjacent rows are spaced apart by about 400 nm or less.

### TECHNICAL FIELD

This disclosure relates to polarizer films, methods for making polarizer films, and system that include polarizer films.

### BACKGROUND

Polarizer films are used in number of applications, such as in liquid crystal displays (LCDs). In general, polarizer films are used to produce polarized light by substantially transmitting incident light of one polarization state, while substantially blocking incident light of the orthogonal polarization state.

Generally, polarizer films are either absorptive polarizer films or reflective polarizer films. Absorptive polarizer films substantially transmit incident light of a first polarization state and substantially absorb incident light of the orthogonal polarization state. Exemplary absorptive polarizer films are formed from a sheet of oriented polyvinyl alcohol that is dyed with iodine. Reflective polarizer films substantially transmit incident light of the first polarization state, but substantially reflect incident light of the orthogonal polarization state.

Certain polarizer films are wire gird polarizers, which includes a number of parallel metal wires that are spaced apart from each other. Typically, the metal wires are spaced to form a periodic structure, where the period is less than the operating wavelength of the polarizer.

### SUMMARY

In general, in a first aspect, the invention features methods that include forming a roll of a first material into a substrate and forming a plurality of rows of a second material on the substrate, where the second material includes a metal, the rows of the second material extend along a first direction, the rows are spaced apart from one another, and adjacent rows are spaced apart by about 400 nm or less.

In general, in another aspect, the invention features methods that include forming a roll of a first material into a substrate and forming a plurality of rows of a second material on a surface of the substrate. The rows of the second material extend along a first direction, the rows are spaced apart from one another, and arranged so that the rows form a polarizer that transmits about 60% or more of incident light at wavelength λ having a first polarization state and the polarizer blocks about 60% or more of incident light at wavelength λ having a second polarization state orthogonal to the first polarization state, where is about 700 nm or less.

In general, in a further aspect, the invention features methods that include forming a plurality of rows of a first material on a surface of a polymer substrate, where the first material includes a metal, the rows of the first material extend along a first direction, the rows are spaced apart from one another, and adjacent rows are spaced apart by about 400 nm or less.

In general, in another aspect, the invention features methods that include forming a plurality of rows of a first material on a surface of a polymer substrate, where the rows of the first material extend along a first direction, the rows are spaced apart from one another, and arranged so that the rows form a polarizer that transmits about 60% or more of incident light at wavelength λ having a first polarization state and the polarizer blocks about 60% or more of incident light at wavelength λ having a second polarization state orthogonal to the first polarization state, where is about 700 nm or less.

In general, in a further aspect, the invention features articles that include a polymer substrate having a surface including a plurality of ridges that extend along a first direction and a plurality of rows of a first material, each row of the first material being supported by a corresponding ridge. The first material includes a metal, the rows extend along the first direction, the rows are spaced apart from one another, and adjacent rows are spaced apart by about 400 nm or less.

In general, in another aspect, the invention features articles that include a polymer substrate having a surface including a plurality of ridges that extend along a first direction and a plurality of rows of a first material, each row of the first material being supported by a corresponding ridge. The rows extend along the first direction, the rows are spaced apart from one another, and arranged so that the rows form a polarizer that transmits about 60% or more of incident light at wavelength λ having a first polarization state and the polarizer blocks about 60% or more of incident light at wavelength λ having a second polarization state orthogonal to the first polarization state, where is about 700 nm or less.

Embodiments of the methods and/or articles can include one or more of the following features.

Forming the roll into the substrate can include unwinding the roll to provide the substrate. Forming the plurality of rows can include shaping a surface of the substrate to define a plurality of ridges, wherein the plurality of ridges extend along the first direction. The ridges can have a triangular cross-sectional profile. The plurality of ridges can be formed while the surface of the substrate is at a temperature of about 100° C. or more (e.g., about 200° C. or more). The substrate material can be a thermoplastic material having a softening temperature, Tₛ, and the plurality of ridges are formed while the substrate is at a temperature equal to or greater than Tₛ. Forming the plurality of rows of the first material can include depositing the first material onto the substrate. In certain embodiments, the second material is deposited on the substrate prior to forming the ridges. The deposition can form a continuous layer of the second material and the plurality of rows are formed by forming a plurality of discontinuities in the continuous layer, where the discontinuities extend along the first direction. In some embodiments, the second material is deposited on the substrate after forming the ridges. The second material can be deposited by evaporating the second material onto the substrate. For example, the second material can be thermally evaporated. As another example, the second material can be evaporated using an electron beam. In some embodiments, the second material is deposited by sputtering the second material onto the substrate. Depositing the second material can include directing second material towards the substrate along a direction substantially non-normal to a plane of the substrate.

Shaping the surface to define the ridges can include embossing the surface of the substrate.

Forming the plurality of ridges can include depositing a layer of a third material on a surface of the substrate and forming the ridges from the layer of the third material. In some embodiments, forming the plurality of ridges from the layer of the third material includes molding the third material into the ridges. Forming the plurality of ridges from the layer of the third material can include curing the third material. For example, the third material can be cured by exposing the third material to radiation (e.g., electromagnetic radiation, such as ultraviolet radiation, or electron beam radiation).

The ridges can have a triangular, rectangular, or trapezoidal cross-sectional profile.

The first material can be a polymer (e.g., a thermoplastic). In some embodiments, the first material is highly transmissive at a wavelength λ less than about 700 nm.

The substrate can have a thickness of about 500 μm or less. The metal can be aluminum or silver.

Adjacent rows of second material can be spaced apart by about 200 nm or less (e.g., by about 100 nm or less). The rows of second material can be arranged to form a grating having a period of about 400 nm or less (e.g., about 200 nm or less).

In certain embodiments, the rows are arranged to form a polarizer that transmits about 60% or more of incident light at wavelength λ having a first polarization state and the polarizer blocks about 60% or more of incident light at wavelength λ having a second polarization state orthogonal to the first polarization state, where λ is about 200 nm or more. λ can be about 2,000 nm or less (e.g., about 700 nm or less).

The polarizer can transmit about 80% or more (e.g., about 90% or more, about 95% or more) of incident light at wavelength λ having the first polarization state. The polarizer can block about 80% or more (e.g., about 90% or more) of incident light at wavelength λ having the second polarization state. In some embodiments, the polarizer reflects about 60% or more (e.g., about 70% or more, about 80% or more, about 90% or more) of incident light at wavelength λ having the second polarization state.

In some embodiments, forming the substrate includes unwinding the roll and the roll is continuously unwound while the plurality of rows are formed on the substrate. The methods can include forming one or more additional layers on the substrate. The methods can include cutting the substrate after forming the plurality of rows to provide a polarizer film product.

In a further aspect, the invention features displays that include a liquid crystal panel, an article of the foregoing aspects, and a display housing containing the liquid crystal panel and the article.

Embodiments include methods for economically forming wire grid polarizer films, e.g., broadband visible wire grid polarizer films. The methods can be used to form large area wire grid polarizer films. Methods may be implemented in a continuous (e.g., roll-to-roll process) allowing relatively large amounts (e.g., hundreds or thousands of square meters) of polarizer films to be produced during a single production run.

Wire grid polarizer films may be produced using methods that do not include any etch steps, simplifying their production. For example, wire grid polarizers can be formed by depositing a metal onto a substrate that has a surface with a number of parallel ridges. A wire grid is formed by depositing the metal only onto a portion of each groove.

Alternatively, wire grid polarizers can be formed by scoring a layer of a metal on a transparent substrate. Further, the production methods can allow for a broader range of materials to be used to form wire grid polarizer films compared to certain methods that involve etch steps. For example, wire grid polarizers can be formed on various polymer substrates.

Embodiments include wire grid polarizers formed on flexible substrates (e.g., substrates that can be used in roll-to-roll manufacturing processes). Accordingly, the wire grid polarizers can be used in applications that demand non-planar configurations of a polarizer film. Further, the embodiments of wire grid polarizer films are relatively robust and can withstand impacts and bending stresses to a larger extend than, e.g., wire grid polarizers formed on glass substrates.

Embodiments include polarizer films that can be advantageously used in various applications like liquid crystal displays (LCDs). For example, reflective polarizer films can be used in transmissive LCDs to increase display brightness by recycling block state radiation from the display's light source. Reflective polarizer films can also be used as rear polarizers for reflective LCDs.

Other features and advantages of the invention will be apparent from the description, drawings, and claims.

### DESCRIPTION OF DRAWINGS

FIG. 1A is a perspective view of an embodiment of a polarizer film.

FIG. 1B is a cross-sectional view of the polarizer film shown in FIG. 1A.

FIG. 2A is a perspective view of an embodiment of a polarizer film.

FIG. 2B is a cross-sectional view of the polarizer film shown in FIG. 2A.

FIG. 3 is a schematic diagram of a manufacturing line for producing polarizer films.

FIGS. 4A-4D are schematic diagrams of various portions of the manufacturing ling shown in FIG. 3.

FIG. 5 is a perspective view of an embodiment of a polarizer film.

FIG. 6 is a schematic diagram of a manufacturing line for producing polarizer films.

FIGS. 7A-7C are schematic diagrams of various portions of the manufacturing ling shown in FIG. 6.

FIG. 8 is a schematic diagram of a manufacturing line for producing polarizer films.

FIG. 9A is a cross-sectional view of an embodiment of a polarizer film.

FIG. 9B is a cross-sectional view of an embodiment of a polarizer film.

FIG. 9C is a cross-sectional view of an embodiment of a polarizer film.

FIG. 9D is a cross-sectional view of an embodiment of a polarizer film.

FIG. 10 is a cross-sectional view of a liquid crystal display including a polarizer film.

FIG. 11 is a schematic diagram of a display system incorporating the liquid crystal display shown in FIG. 10.

Like reference symbols in the various drawings indicate like elements.

### DETAILED DESCRIPTION

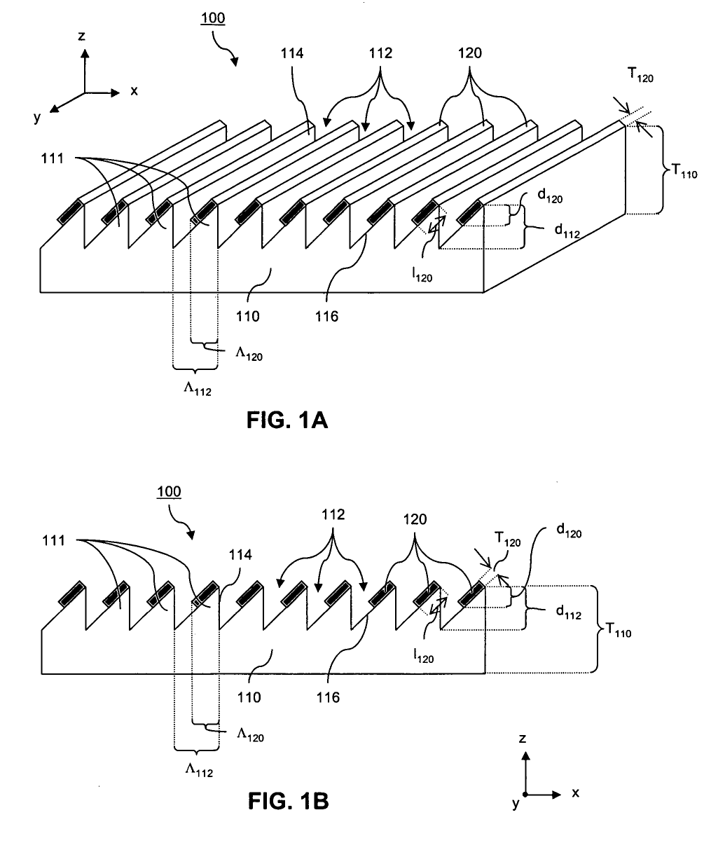

Referring to FIGS. 1A and 1B, an embodiment of a polarizer film 100 includes a substrate 110 (e.g., a flexible substrate) that has a surface that includes a number of grooves 112 that extend parallel to one another. Substrate 110 extends in a plane corresponding to the x-y plane for the Cartesian co-ordinate system shown in FIGS. 1A and 1B. Grooves 112 extend in the y-direction. Grooves 112 are separated by corresponding ridges 111, each defined by a first side 114 and a second side 116. Grooves 112 and ridges 111 are shaped so that substrate 110 has a sawtooth cross-sectional profile, where sides 114 are oriented parallel to the z-axis. Each second side 116 supports a corresponding row 120 of a non-transmissive material (e.g., a material that reflects or absorbs incident radiation at the polarizer film's operational wavelength(s)) that also extends in the y-direction. Adjacent rows 120 are spaced apart from each other, forming a grating structure periodic in the x-direction. In embodiments where the non-transmissive material is a metal, polarizer film 100 is an example of a wire grid polarizer.

In general, the features of polarizer film 100 are selected so that the film polarizes visible light of wavelength λ propagating in the z-direction. In other words, for visible light of wavelength λ incident on polarizer film 100 propagating parallel to the z-axis, polarizer film 100 transmits about 60% or more (e.g., about 80% or more, about 90% or more, about 95% or more, about 98% or more, about 99% or more) of the component of incident light plane-polarized in the x-direction (referred to as “pass” state polarization) while blocking about 60% or more (e.g., about 80% or more, about 90% or more, about 95% or more, about 98% or more, about 99% or more) of the component plane-polarized in the y-direction (referred to as “block” state polarization). Visible light refers to light in the 380 nm to 780 nm wavelength range.

Generally, polarizer film 100 blocks about 60% or more of incident radiation at λ having the block state polarization by reflecting and/or absorbing that radiation. For example, polarizer film 100 can reflect about 60% or more of incident radiation at λ having the block polarization state (e.g., about 80% or more, about 90% or more, about 95% or more). When polarizer film 100 reflects a relatively large amount block state radiation, absorption of the block state radiation is relatively low. For example, block state absorption can be about 10% or less (e.g., about 5% or less).

Alternatively, in certain embodiments, polarizer film 100 absorbs about 60% or more of the incident radiation at λ having the block polarization state. For example, where the non-transmissive material substantially absorbs radiation at λ, polarizer film 100 can absorb about 60% or more of the block state polarization (e.g., about 70% or more, about 80% or more).

Polarizer film 100 has a relatively high extinction ratio, E_{T}, for transmitted light at λ. For transmitted light, the extinction ratio refers to the ratio of pass state intensity at λ to the block state intensity transmitted by polarizer film 100 for incident light propagating parallel to the z-axis. E_{T} for polarizer film 100 can be, for example, about 30 or more at λ (e.g., about 50 or more, about 100 or more, about 150 or more). In certain embodiments, where block state transmission is relatively low, E_{T} can be very high, such as about 1,000 or more.

In some embodiments, polarizer film 100 can have a relatively high extinction ratio, E_{R}, for reflected light at B. E_{R} is the ratio of the reflected intensity of block state radiation to the reflected intensity of pass state radiation at λ for incident light propagating parallel to the z-axis. E_{R} for polarizer film 100 can be, for example, about 30 or more (e.g., about 50 or more, about 100 or more, about 150 or more).

In certain embodiments, both E_{T} and E_{R} are relatively high at λ. For example, E_{T} and E_{R} for polarizer film 100 can both be about 30 or more (e.g., about 50 or more, about 100 or more, about 150 or more).

In some embodiments, polarizer film 100 is a broadband visible polarizer. In other words, polarizer film 100 can have relatively high pass state transmission (e.g., about 60% or more, about 70% or more, about 80% or more, about 90% or more, about 95% or more) and a high pass state extinction ratio (e.g., about 30 or more, about 50 or more, about 100 or more, about 150 or more) for each wavelength in a range of wavelengths, e.g., the entire visible spectrum. In certain embodiments, polarizer film 100 has relatively high pass state transmission and high pass state extinction for wavelengths in a range from about 300 nm to about 800 nm (e.g., from about 400 nm to about 700 nm, from about 500 nm to about 600 nm).

In some embodiments, polarizer film 100 can be a relatively large sheet of film. Of course, large sheets of film will include more grooves and rows than are illustrated in FIGS. 1A and 1B. Polarizer film 100 can have a relatively large area in the x-y plane, such as about 100 square inches or more (e.g., about 500 square inches or more, about 1,000 square inches or more). Polarizer film 100 can have a diagonal dimension in the x-y plane of about 2 inches or more (e.g., about 5 inches or more, about 15 inches or more, about 17 inches or more, about 20 inches or more, about 32 inches or more, about 37 inches or more, about 42 inches or more, about 50 inches or more).

Grooves 112 have a trough-to-trough width Λ₁₁₂ in the x-direction, which corresponds to the grating's period. The grating period is smaller than λ (e.g., smaller than λ/nₛ, where nₛ is the refractive index of the substrate). The short period can result in incident light of wavelength λ propagating parallel to the z-axis interacting with polarizer film 100 without encountering significant high-order diffraction that may occur when light interacts with periodic structures.

In certain embodiments, Λ₁₁₂ is less than 0.8λ, such as about 0.5λ or less (e.g., about 0.3λ or less, about 0.2λ or less, about 0.1λ or less, about 0.08λ or less, about 0.05λ or less, about 0.04λ or less, about 0.03λ or less, about 0.02λ or less, 0.01λ or less). In some embodiments, Λ₁₁₂ is about 500 nm or less (e.g., about 300 nm or less, about 200 nm or less, about 150 nm or less, about 130 nm or less, about 100 nm or less, about 80 nm or less, about 60 nm or less, about 50 nm or less, about 40 nm or less).

Substrate 110 has a thickness, T₁₁₀, which here refers to the maximum dimension of the substrate in the z-direction. In general, T₁₁₀ can vary and is usually selected to be relatively thin while providing sufficient mechanical support and protection for grooves 112 and rows 120. In certain embodiments, T₁₁₀ is in a range from about 10 μm to about 1,000 μm (e.g., about 50 μm or more, about 100 μm or more, about 500 μm or less, about 300 μm or less).

Rows 120 have a width Λ₁₂₀ in the x-direction. In general, Λ₁₂₀ is less than Λ₁₁₂. In certain embodiments, Λ₁₂₀ is about 0.2λ or less (e.g., about 0.1λ or less, about 0.05λ or less, about 0.04λ or less, about 0.03λ or less, about 0.02λ or less, 0.01λ or less). For example, in some embodiments, Λ₁₂₀ is about 200 nm or less (e.g., about 150 nm or less, about 100 nm or less, about 80 nm or less, about 70 nm or less, about 60 nm or less, about 50 nm or less, about 40 nm or less, about 30 nm or less).

The duty cycle of the grating, given by the ratio Λ₁₂₀/Λ₁₁₂, can vary as desired. In some embodiments, the duty cycle is less than about 50% (e.g., about 40% or less, about 30% or less, about 20% or less). Alternatively, in certain embodiments, the duty cycle is more than about 50% (e.g., about 60% or more, about 70% or more, about 80% or more).

Grooves 112 have a depth d₁₁₂. In this case d₁₁₂ refers to the dimension of the grooves measured from their tip to their trough along the z-axis. In general, groove depth d₁₁₂ can vary as desired. d₁₁₂ can be less than λ, such as about 0.5λ or less (e.g., about 0.3λ or less, about 0.2λ or less, about 0.1λ or less, about 0.08λ or less, about 0.05λ or less, about 0.04λ or less, about 0.03λ or less, about 0.02λ or less, 0.01λ or less). In some embodiments, d₁₁₂ is about 500 nm or less (e.g., about 300 nm or less, about 200 nm or less, about 150 nm or less, about 130 nm or less, about 100 nm or less, about 80 nm or less, about 60 nm or less, about 50 nm or less, about 40 nm or less).

Rows 120 have a depth d₁₂₀, which refers to the dimension of a surface of the rows measured along the z-axis. d₁₂₀ can vary and is generally less than or equal to d₁₁₂. d₁₂₀ can be less than λ, such as about 0.5λor less (e.g., about 0.3λor less, about 0.2λ or less, about 0.1λ or less, about 0.08λ or less, about 0.05λ or less, about 0.04λ or less, about 0.03λ or less, about 0.02λ or less, 0.01λ or less). In some embodiments, d₁₂₀ is about 300 nm or less (e.g., about 200 nm or less, about 150 nm or less, about 100 nm or less, about 80 nm or less, about 60 nm or less, about 50 nm or less, about 40 nm or less, about 30 nm or less, about 20 nm or less).

Rows 120 can also be characterized by a dimension 1120, which is the length of the row surface contacting the groove in the x-z plane. For polarizer film 100, 1120 corresponds to (d₁₂₀+Λ₁₂₀²)^{0.5}

Rows 120 also have a thickness, T₁₂₀, which corresponds to the rows' dimension perpendicular to the surfaces of grooves 112 supporting the rows. T₁₂₀ may vary as desired and is typically less than less than λ, such as about 0.5λ or less (e.g., about 0.3λ or less, about 0.2λ or less, about 0.1λ or less, about 0.08λ or less, about 0.05λ or less, about 0.04λ or less, about 0.03λ or less, about 0.02λ or less, 0.01λ or less). In some embodiments, T₁₂₀ is about 300 nm or less (e.g., about 200 nm or less, about 150 nm or less, about 100 nm or less, about 80 nm or less, about 60 nm or less, about 50 nm or less, about 40 nm or less, about 30 nm or less, about 20 nm or less).

The composition of substrate 110 and rows 120 are selected so that polarizer film 100 has desired polarizing properties. As mentioned previously, rows 120 are formed from a material that is non-transmissive at λ. As used herein, a non-transmissive material refers to a material that, for a 1 mm thick sample, transmits less than 1% (e.g., about 0.5% or less, about 0.1% or less, about 0.01% or less, about 0.001% or less) of radiation at λ. Non-transmissive materials include materials that reflect and/or absorb a relatively large amount of radiation at λ. Examples of non-transmissive materials for visible and infrared wavelengths include various metals, such as Al, Au, Ag, Cr, and Cu, as well as metal alloys. Al and Ag are examples of materials that have high reflectance across the visible portion of the electromagnetic spectrum, while Au and Cu have high reflectance for the yellow and red portions of the spectrum, while absorbing relatively more of the shorter visible wavelengths (e.g., the green and blue wavelengths).

In general, the material forming rows 120 can include inorganic and/or organic constituent materials. Examples of inorganic materials include metals, semiconductors, and inorganic dielectric materials (e.g., glass). In certain embodiments, rows 120 include a metal, such as those metals mentioned above. Rows 120 can be formed from more than one metal (e.g., from a metal alloy). Examples of organic materials include polymers, such as polymers that include chromophores or dyes selected to absorb light at λ.

In addition to their optical properties, the composition of rows 120 is typically selected based on its compatibility with the processes used to manufacture polarizer film 100 and its compatibility with the materials used to form other layers of polarizer 100. For example, rows 120 are formed from materials that can be deposited on substrate 110 using methods that do not damage the substrate, such as methods that do not require extreme temperatures or chemical exposure that would damage the substrate. Furthermore, in some embodiments, rows 120 are formed from materials that can be directionally deposited on the substrate. Directional deposition is discussed below.

Substrate 110 is formed from a highly transmissive material. A one millimeter thick sample of a highly transmissive material transmits about 80% or more of radiation at λ (e.g., about 90% or more, about 95% or more, about 98% or more, about 99% or more). Examples of highly transmissive materials for visible and/or near infrared wavelengths (e.g., from about 780 nm to about 1,600 nm) include various inorganic dielectric materials, such as SiO₂, and various organic materials, such as certain polymers (e.g., certain forms of methacrylate polymers (e.g., poly(methyl methacrylate) (PMMA)), polycarbonate (PC), polyethylene terephthalate (PET), triacetate cellulose (TAC), cyclic olefin polymers, styrenic polymers, certain fluorine-containing polymers, polyesters, polyvinyl chloride (PVC), polyethersulfone, polyethylene (PET), polypropylene (PP), various polyimides, and copolymers of such polymers).

As mentioned previously, in certain embodiments, substrate 110 is formed from a flexible material, e.g., a material suitable for roll-to-roll processing. Certain polymers, such as those mentioned above, are examples of such materials. Substrate 110 may be formed from a thermoplastic polymer or a thermoset polymer. In some embodiments, substrate 110 can include a metal thin film.

Polymers used for substrate 110 can include one or more additives. For example, polymers can include additives which affect their mechanical properties. Plasticizers, as an example, can be used to increase the flexibility of the substrate. In some embodiments, a cross-linking agent can be used to increase the rigidity of the substrate.

In general, the structure and composition of polarizer film 100 is selected based on the desired optical performance of the polarizer film. Structural parameters that affect the optical performance of polarizer film 100 include, for example, Λ₁₁₂, Λ₁₂₀, d₁₁₂, d₁₂₀, and T₁₂₀. Typically, varying a single parameter affects multiple different performance parameters. For example, the overall transmission of the polarizer film at λ can be varied by changing the duty cycle of the grating. Generally, a larger duty cycle will reduce the overall transmission of the pass state light by the polarizer film. However, this reduced transmission can be accompanied by increased blocking of the block state light, which may result in an overall increase in E_{T}. More generally, optimizing the polarizer's performance involves trade offs between different performance parameters and the polarizer's structure and composition is varied depending on the desired performance for the polarizer's end use application.

In general, to effectively polarize light at wavelength λ, the period Λ₁₁₂ of the grating layer should be shorter than λ, such as about λ/4 or less (e.g., about λ/6 or less, about λ/10 or less). Moreover, for effective broadband performance, Λ should be shorter than the shortest wavelength in the wavelength band. For a broadband polarizer in the visible spectrum, for example, Λ₁₁₂ should be less than about 300 nm, such as about 200 nm or less (e.g., about 150 nm or less, about 130 nm or less, about 110 nm or less, about 100 nm or less, about 90 nm or less, about 80 nm or less).

In some embodiments, E_{T} can be increased by increasing the depth of rows 120, d₁₂₀. Increasing d₁₂₀ can provide increased E_{T} without substantially reducing the amount of pass state transmission.

As discussed, the optical properties of the materials composing portions 111 and 112 also affect the optical performance of polarizer 100. For example, polarizer transmission can be increased by forming substrate 110 from a material that has a relatively high transmission at λ.

Furthermore, where high reflectivity of the block state polarization is desired, rows 120 should be formed from a material that has a high reflectivity at λ. Moreover, where high reflectivity of the block state polarization is desired for a broad band of wavelengths, the material should have a relatively high reflectivity for all wavelengths in the band. As an example, Al provides higher broadband reflectivity for visible wavelengths compared to Au or Cu, for example, which have higher absorption for shorter visible wavelengths.

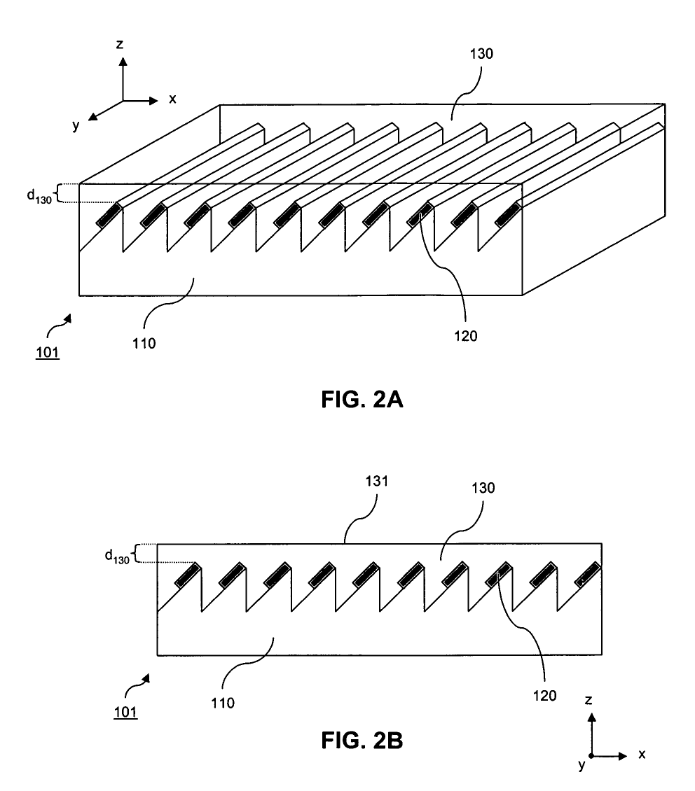

Referring to FIGS. 2A and 2B, in some embodiments, polarizer films can include a layer 130 of a material that covers rows 120. This layer can be formed from a material selected to protect rows 120 and grooves 112 from, e.g., environmental damage and/or to provide planar surface 131 on top of the grooves. Layer 130 can be formed from a physically hard material (e.g., a material that is resistant to abrasive damage relative to the material forming rows 120). For example, layer 130 can be formed from an epoxy or polyurethane. Alternatively, or additionally, the material used to form layer 130 can be selected based on its impermeability to certain hazardous environmental, such as water. For example, layer 130 can be formed from a hydrophobic material, such as a fluoropolymer (e.g., Teflon (PTFE).

Typically, layer 130 is formed from a material that is highly transmissive at the polarizer film's operational wavelengths (e.g., such as a highly transmissive polymer). In some embodiments, layer 130 is formed from a photocurable polymer, such as a resin (e.g., an acrylate resin) that includes a photoinitiator. In some embodiments, layer 130 is formed from a material that is the same as the material forming substrate 110.

The thickness of layer 130 along in the z-direction is designated d₁₃₀. In general, d₁₃₀ can vary as desired. d₁₃₀ can be selected to provide a desired mechanical stiffness or flexibility to the polarizer film. In some embodiments, d₁₃₀ can be about 100 nm or more (e.g., about 200 nm or more, about 500 nm or more, about 1 μm or more). In certain embodiments, d₁₃₀ is in a range from about 1 μm to about 10 μm or less (e.g., to about 5 μm, to about 3 μm).

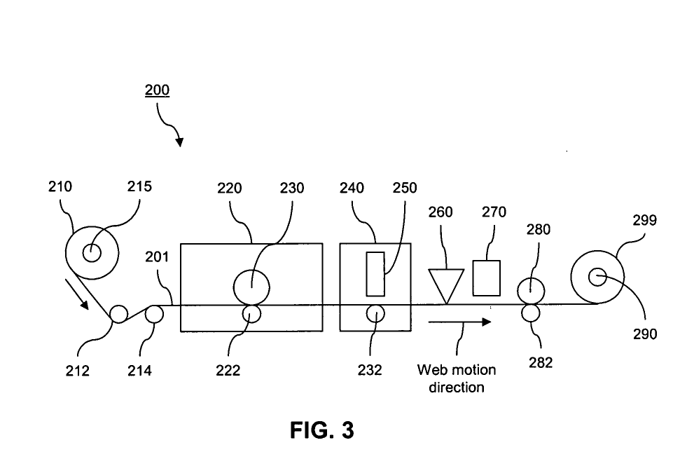

Polarizer films, such as polarizer film 100, can be manufactured in a continuous manufacturing process (e.g., a roll-to-roll process). Referring to FIG. 3, an embodiment of a polarizer film manufacturing line 200 is shown that is configured to manufacture polarizer films in a continuous, roll-to-roll process. Line 200 includes an unwind station 215, which unwinds a roll 210 of substrate material to provide a continuous web 201. Line 200 also includes a rotating, embossing roller 230 positioned within an oven 220. Embossing tool 230 forms grooves in the surface of web 201 as the web moves past the tool. Down stream from embossing tool 230, line 200 includes a deposition station 240. Deposition station 240 includes a deposition tool 250 which deposits non-transmissive material onto the grooves to form the rows of the non-transmissive material in the polarizer film. A coater 260 then deposits an overcoat onto the grooves and rows of non-transmissive material. A curing station 270 cures the overcoat. Subsequently, a polishing wheel 280 planarizes the cured overcoat and the polarizer film is wound into a roll 299 at a rewind station 290. Line 200 also includes rollers 212, 214, 222, 232, and 282 which support and control tension in web 201. In addition, rollers 222 and 282 can be adjusted to control the pressure of embossing tool 230 and polishing wheel 280 on web 201, respectively.

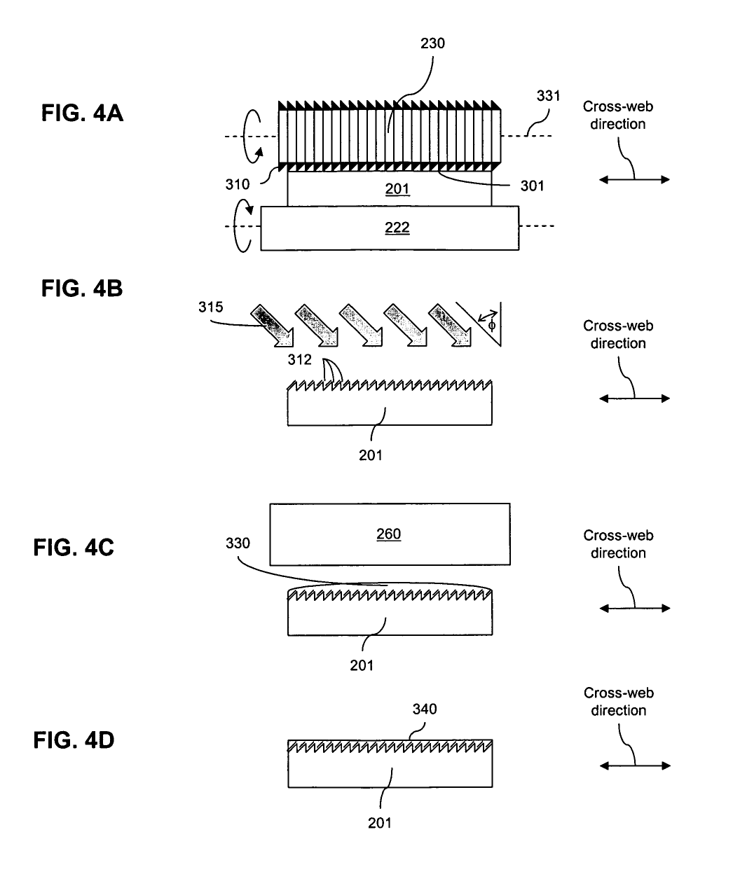

Referring also to FIGS. 4A-4D, the surface of embossing roller 230 includes a number of ridges 310, which contact the surface of web 201 as it passes by embossing tool 230 (the direction of motion is perpendicular to the plane of FIG. 4A). Oven 220 heats web to a temperature at which the surface of the substrate is sufficiently soft so that, with appropriate pressure, ridges 310 impress their pattern into substrate surface 301, forming a number of parallel grooves. Embossing tool 230 rotates about an axis 331 as web 201 passes between the embossing tool and roller 220 (which also rotates).

The temperature of web 201 at embossing tool 230 depends on the composition of the substrate, but is sufficiently high so that surface 301 can be easily impressed with ridges 310. For example, for thermoplastic substrates, web 201 can be at a temperature that is at or higher than the substrate material's softening point. A material's softening point is the temperature at which a specimen of the material is penetrated to a depth of 1 mm by a flat-ended needle with a 1 sq. mm circular or square cross-section, under a 1000-gm load. In some embodiments, the temperature of web 201 at embossing tool 230 is about 50° C. or more (e.g., about 75° C. or more, about 100° C. or more, about 125° C. or more, about 150° C. or more, about 175° C. or more, about 200° C. or more, about 225° C. or more, about 250° C. or more, about 275° C. or more, about 300° C. or more). Generally, the temperature of the web in oven 220 should not be so high that the web deforms under its own weight or that surface 301 does not retain the grooves formed when impressed with ridges 310 after it passes embossing tool 230. In certain embodiments, web 201 is heated to a temperature of about 500° C. or less (e.g., about 450° C. or less, about 400° C. or less, about 350° C. or less, about 300° C. or less). In certain embodiments, web 201 is heated to a temperature of between about 100° C. and 200° C. (e.g., between about 125° C. and 175° C.) at embossing tool 230.

Ridges 310 on surface of embossing tool 230 run parallel to the web motion direction when embossing tool 230 contacts surface 301 of web 201. More generally, the orientation of the embossing tool ridges with respect to the web direction can vary. For example, the ridges can be non-parallel with the web motion direction (e.g., perpendicular to the web motion direction). In some embodiments, the ridges are oriented at about 45° with respect to the web motion direction.

Embossing roller 230 can be made by attaching one or more flexible molding elements to a surface of a cylindrical roller. The surface structure of the molding elements is effectively the negative of the desired sawtooth profile to be impressed into surface 301 of web 201. In some embodiments, the surface structure of the molding elements can be dimensioned to accommodate dimensional changes in surface 301, e.g., after it cools upon leaving oven 220.

The molding elements can be formed using lithographic techniques, such as photolithography, electron-beam lithography, or imprint lithography (e.g., nanoimprint lithography). For example, in certain embodiments, electron beam lithography is used to form a primary mold having the desired groove pattern for the polarizer film. Conventional methods (e.g., conventional exposure and etch methods) and materials can be used to form the primary mold. In some embodiments, the primary mold is formed in a surface of a glass substrate, for example. Subsequently, the primary mold is used to form molding elements using imprint lithography techniques (e.g., nanoimprint lithography).

Typically, the molding elements are formed so that they are sufficiently flexible to be wrapped around a cylindrical roller to form roller 230. In some embodiments, the molding elements are formed from nickel shims that are sufficiently thin to be conformed to the surface of a cylindrical roller.

In some embodiments, the surface of embossing roller 230 can be coated with one or more materials that facilitate the functioning or durability of the tool. For example, in certain embodiments, embossing roller 230 is coated with a release agent to facilitate a clean release between the ridges on the roller and the web surface (e.g., a silane release agent).

In some embodiments, embossing roller includes materials that make the roller more durable. For example, the roller's surface can be coated with a hardening agent, such as a diamond coating or a hard metal layer (e.g., Tungsten).

At deposition station 240, deposition tool 250 deposits a non-transmissive material onto grooves 312 formed in the surface of web 201 (see FIG. 4B). Non-transmissive material is deposited at an angle φ with respect to the web normal 316. Due to the non-normal deposition, a portion of each groove 312 is in the shadow of the adjacent ridge, so the non-transmissive material is deposited onto only a portion of each groove, forming the spaced-apart rows. φ is generally selected based on the dimension and orientation of the sides of grooves 312. In some embodiments, φ can be relatively close to normal to the plane of substrate 201. For example, φ can be about 25° or less (e.g., about 20° or less, about 15° or less, about 10° or less). Alternatively, in certain embodiments, φ can be more than 25° (e.g., about 30° or more, about 35° or more, about 40° or more, about 45° or more, about 50° or more, about 55° or more, about 55° or more, about 60° or more, about 65° or more, about 70° or more, about 75° or more, about 80° or more). In some embodiment, φ is selected to be substantially perpendicular to one of the sides of grooves 312.

In general, any directional deposition method can be used to form the rows of non-transmissive material. In some embodiments, the non-transmissive material can be evaporated onto grooves 312 (e.g., via electron beam or thermal evaporation). In certain embodiments, sputtering methods can be used to deposit the non-transmissive material. Sputtering may be performed with a mask (e.g., to provide directional deposition by blocking sputtered material propagating along undesirable trajectories).

Coater 260 deposits a layer 330 of an overcoat material over the grooves and rows of non-transmissive material (see FIG. 4C). The overcoat material wets grooves and rows of non-transmissive material, filling in the grooves. Typically, the overcoat material is a polymer or polymer precursor (e.g., including monomers and/or oligomers) that is subsequently cured. The overcoat material can be deposited at ambient temperature (e.g., at room temperature) or can be deposited at an elevated temperature (e.g., to facilitate wetting of the web surface). In some embodiments, layer 330 is deposited in a solvent (e.g., water or an organic solvent). A solvent can facilitate wetting of the substrate surface and can improve the uniformity of coverage of layer 330.

Overcoat layer 330 is cured at curing station 270. In some embodiments, curing involves exposing overcoat layer 330 to radiation (e.g., ultraviolet, visible, electron beam radiation). In certain embodiments, overcoat layer 330 is cured by exposure to a reagent. Curing station 270 introduces the reagent (e.g., a gaseous reagent, such as oxygen) to the web environment, causing overcoat layer 330 to cure.

After curing, overcoat layer 330 is polished at polishing wheel 280 to form a flat surface 340 (see FIG. 4D). Typically, polishing wheel 280 has a surface that is sufficiently abrasive to slough off uneven portions of the surface of cured layer 330, but with a fine enough grain so that surface 340 is relatively smooth. Alternatively, if the coating provides layer 330 with a sufficiently smooth and flat surface, no polishing may be necessary.

In some embodiments, overcoat layer 330 is applied as a layer of a liquid (e.g., a liquid resin) and a roller is used to planarize the surface of layer 330 prior to curing the layer. In this way, a planar overcoat may be provided without polishing.

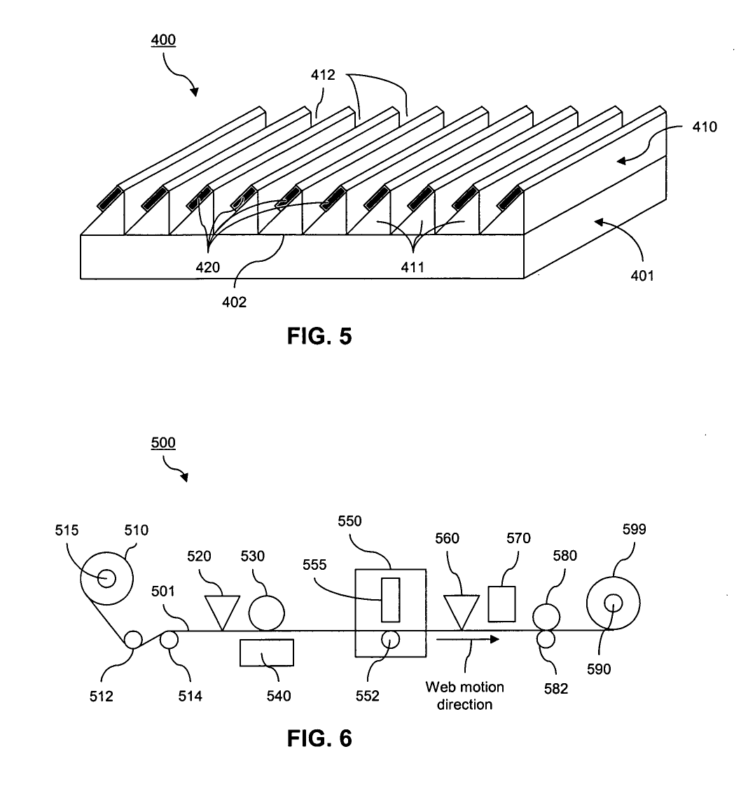

While in the foregoing, grooves are formed directly into the surface of a single layered substrate, in general, other polarizer film structures are also possible. Referring to FIG. 5, a further embodiment of a polarizer film 400 includes a substrate that includes a first layer 401 and a second layer 410 on a surface of first layer 401. Second layer 410 is in the form of a number of ridges 411, which define grooves 412. A row 420 of non-transmissive material is formed on top of each ridge 411.

Ridges 411 are formed from a transmissive material, such as a transmissive polymer or inorganic dielectric material. The material used to form ridges 411 may be the same or different as that used for layer 401.

Referring to FIG. 6, an embodiment of a production line 500 is shown. Production line 500 is configured to produce polarizer films having a structure like that of polarizer film 400. Production line 500 includes an unwind station 515, which unwinds a roll 510 of substrate material to provide a continuous web 501. Downstream from unwind station 515, line 500 includes a first coater 520 that deposits a layer of a ridge material onto the surface of web 501. Next, an embossing roller 530 imprints ridges into the layer of ridge material while the ridge material is cured by exposure to a curing agent from station 540.

Downstream from embossing tool 530, line 200 includes a deposition station 550 that includes a deposition tool 555 which deposits non-transmissive material onto the ridges to form the rows of the non-transmissive material in the polarizer film. A second coater 560 then deposits an overcoat onto the ridges and rows of non-transmissive material. A curing station 570 cures the overcoat. Subsequently, a polishing wheel 580 planarizes the cured overcoat and the polarizer film is wound into a roll 599 at a rewind station 590. Line 500 also includes rollers 512, 514, 522, 532, and 582 which support and control tension in web 501.

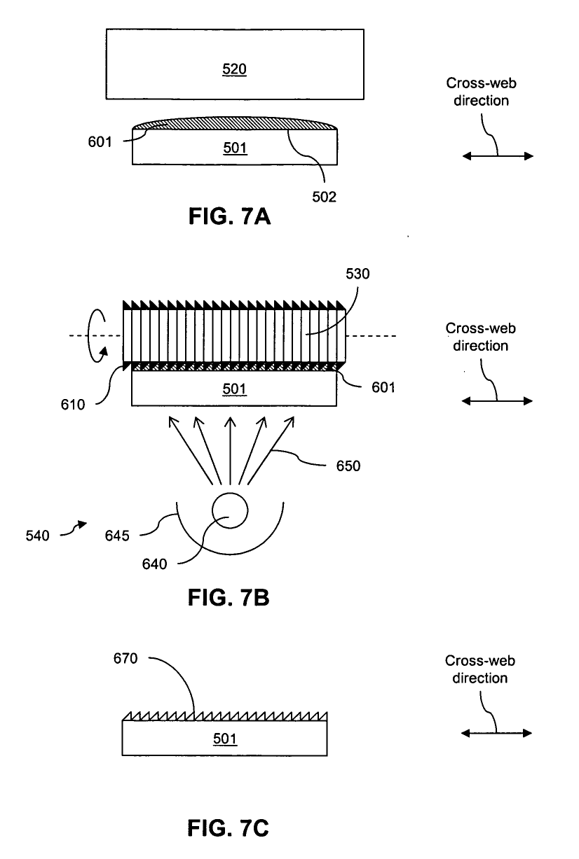

Referring also to FIGS. 7A-7C, first coater 520 deposits a layer 601 of ridge material or a precursor to the ridge material onto the surface 502 of web 501. The deposited material is usually of low viscosity and readily wets surface 601. For example, in embodiments where the ridge material is a thermoplastic, the deposited material can be heated to a temperature at which it has relatively low viscosity. In embodiments where the ridge material is a thermoset, for example, the material deposited onto surface 502 can be uncured material. Where curing is necessary to set the ridge material, station 540 exposes layer 601 to a curing agent while layer 601 is pressed against ridges 610 of embossing tool 630.

The ridge material, or a precursor to the ridge material, can be coated in a solution, where the solvent subsequently evaporates leaving behind a layer of the ridge material or precursor. Solvents are generally selected based on their compatibility with the substrate material and the ridge material or precursor. Examples of solvent include water and organic solvents, such as alcohol, acetone, toluene, and ethylmethylketone.

In some embodiments, radiation (e.g., ultraviolet, visible, or electron beam radiation) is used to cure layer 601. FIG. 7B shows an embodiment where station 540 includes a light source 640 (e.g., an ultraviolet and/or visible light source) and a reflector 645 which direct radiation 650 to layer 601 through web 501 while the web is adjacent embossing tool 530. After curing, web 501 includes a layer 670 of ridges, onto which non-transmissive material can be deposited (see FIG. 7C).

Exemplary resins that can be cured by radiation can include one or more monomers (e.g., lauryl methacrylate monomer) and/or oligomers (e.g., ethoxylate bisphenol-A dimethacrylate), along with a photoinitiator (e.g., Darocure or Irgacure). Further, resins can include one or more additional components, such as a viscosity controller (e.g., Diisooctyl Phthalate), a lubricant (e.g., Loxiol G70), and a photosensor (e.g., Benzophenone), and/or a surface modifier (e.g., 2,2,2-trifliuoroethyl methacrylate)

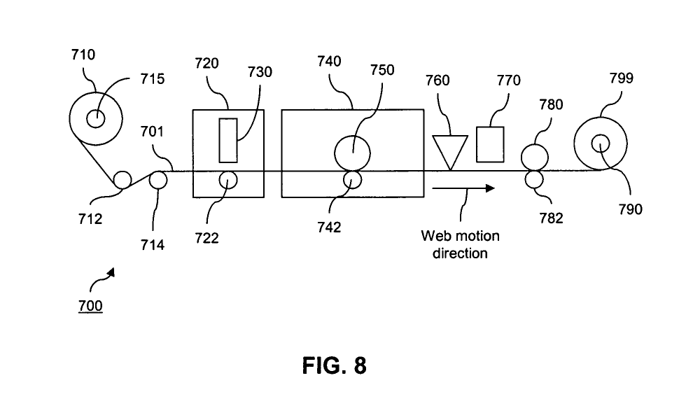

In the foregoing, non-transmissive material is deposited on the substrate surface after the grooves have been formed. However, in some embodiments, the non-transmissive material is deposited onto the substrate prior to forming grooves in the substrate surface. Referring to FIG. 8, a polarizer film manufacturing line 700 is configured to form grooves on a web that includes a layer of non-transmissive material. Line 700 includes an unwind station 715, which unwinds a roll 710 of substrate material to provide a continuous web 701. Downstream from unwind station 715, line 700 includes a deposition station 720 that includes a deposition tool 730 (e.g., an evaporator) configured to deposit a layer of non-transmissive material onto the surface of web 701. Next, web 701 enters an oven 740 in which an embossing roller 750 imprints ridges into the web surface and the layer of non-transmissive material. Embossing tool 750 forms a row of the non-transmissive material on each ridge.

Downstream from embossing tool 750 and oven 740, line 700 includes a coater 760 that deposits an overcoat onto the ridges and rows of non-transmissive material. A curing station 770 cures the overcoat. Subsequently, a polishing wheel 780 planarizes the cured overcoat and the polarizer film is wound into a roll 799 at a rewind station 790. Line 700 also includes rollers 712, 714, 722, 742, and 782 which support and control tension in web 701.

While certain polarizer film manufacturing lines have been described, other embodiments are also possible. For example, in some embodiments, different manufacturing steps can be performed on different manufacturing lines. As an example, ridges can be formed on a substrate using a first manufacturing line, while non-transmissive material is deposited on the ridges using a second manufacturing line (e.g., where vacuum conditions are necessary to provide the desired deposit on the ridges).

Polarizer film manufacturing lines can include additional components in addition, or as alternative to the components shown in the production lines described above. For example, in some embodiments, production lines can include an in-line die cutter for cutting the continuous web polarizer film into individual polarizer film products.

In some embodiments, production lines can include a further coating station for coating an adhesive layer onto one surface of the web. Further, a laminating station can be used to laminate a release liner onto the side of the web that has the adhesive layer.

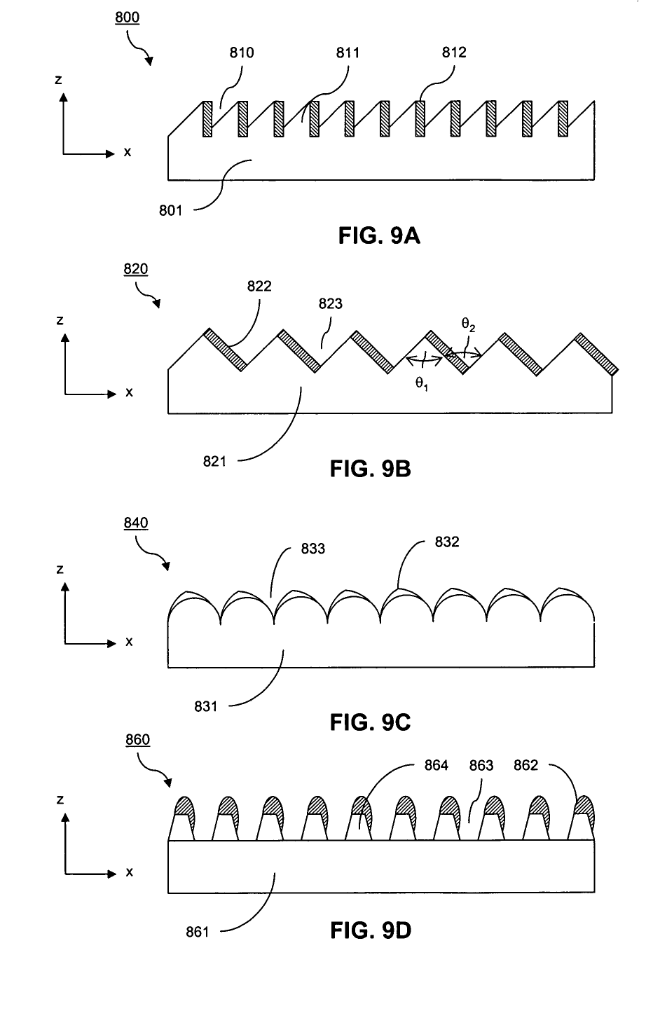

As another example, production lines can include components that adjust the orientation of the reflective rows from their orientation that results from embossing. In some embodiments, a polarizer film production line includes a buffing roller that includes brushes the reflective rows so that they orient substantially vertically on the film (i.e., with their long axis parallel to the z-direction. Referring to FIG. 9A, a polarizer film 800 includes grooves 810 and ridges 811 arranged in a sawtooth profile, where the rows of non-transmissive material are deposited on the side of the ridges parallel to the z-axis. More generally, polarizer films can have cross-sectional profiles different than those described above. For example, referring to FIG. 9B, a polarizer film 820 that includes a surface with grooves 823 and ridges 822 has a triangular cross-sectional profile where adjacent sides of each ridge subtend a substantially equal angle with respect to the z-axis. In general, a triangular cross-sectional profile can be characterized by a ridge angle, θ₁, and a groove angle, θ₂. For a perfectly triangular profile such as the profile shown in FIG. 9B and the sawtooth profiles described above, θ₁=θ₂. In some embodiments, θ₁ and θ₂ are 90° or greater (e.g., about 100° or more, about 120° or more, about 140° or more). Alternatively, in certain embodiments, θ₁ and θ₂ are less than 90° (e.g., about 80° or less, about 70° or less, about 60° or less, about 50° or less).

Further, polarizer films can have non-triangular cross-sectional profiles. In some embodiments, for example, can have grooves with a rectangular, trapezoidal; arcuate or irregular cross-sectional profile. Referring to FIG. 9C, as an example, a polarizer film 840 includes arcuate ridges 841. Each ridge 841 is a convex ridge and supports a corresponding row 842 of a non-transmissive material.

Referring to FIG. 9D, an example of a polarizer film 860 having a trapezoidal ridges is shown. Film 860 includes a substrate 861 and trapezoidal ridges 864. Each trapezoidal ridge 864 supports a row 862 of a non-transmissive material. Adjacent ridges are separated by a groove 863.

Furthermore, while the ridges and rows of non-transmissive material are arranged periodically in the x-direction in the described embodiments, other arrangements are also possible. In general, the arrangement of rows can be arranged in any way that provides desired polarizing properties to the film. This may include non-periodic, quasi-periodic, and/or patterns that are periodic over multiple ridges. Further, while the FIGs. depict polarizer profiles having cross-sectional profiles that are perfectly uniform (e.g., perfectly triangular), in general, the cross-section profile will be uniform to within manufacturing tolerances of the production line and the materials.

Moreover, while each row of non-transmissive material is depicted as having an identical cross-sectional shape (e.g., rectangular), in general, the cross-sectional shape of rows of non-transmissive material in a polarizer film can vary slightly from a nominal shape. Further, in general, the nominal cross-sectional shape of the rows of non-transmissive material can vary, and generally depends on the deposition process used to form the rows, for example.

In some embodiments, polarizer films can include one or more additional layers than those described above. In certain embodiments, polarizer films include an additional polarizer layer in addition to the nanostructured (e.g., wire grid) polarizer. For example, in some embodiments, polarizer films can include an absorptive polarizer layer (e.g., iodine-stained, oriented PVA) having its pass state axis parallel to the pass state axis of a nanostructured polarizer can provide a polarizer film with enhanced E_{T} compared to comparable structures without the absorptive polarizer layer. In embodiments, polarizer films can include one or more additional nano-structure layers. For example, the polarizer film can include a nanostructured optical retarder in addition to the wire grid polarizer.

Embodiments can include layers that provide additional optical function. For example, certain polarizer films can include a optical diffuser. An optical diffuser can, for example, be positioned on either or both sides of the nanostructured polarizer. Diffuser layers can be useful, for example, in applications where homogenization of either the pass-state or block-state light is desired (e.g., in a backlight cavity of an LCD). In some embodiments, diffuser layers are formed by dispersing micron-sized scattering centers (e.g., polymer pellets) in an otherwise optically homogeneous material.

Embodiments can include layers that provide a mechanical function. For example, some polarizer films can include an adhesive layer on one or both of its surfaces, allowing a user to integrate it with in its end-use application by bonding it directly to another device. A release liner can be laminated to the adhesive layer. Another example of a layer that provides a mechanical function is a stiffening layers, such as a sheet of a rigid material (e.g., a rigid polymer or a glass).

Additional layers can be deposited onto the same side of the substrate as the ridges and/or onto the opposite side of the substrate as the ridges.

While the foregoing polarizer film embodiments are configured for polarizing visible light, more general, embodiments can include polarizer films configured to polarize other wavelengths. For example, polarizer films can be configured to polarize infrared light in addition, or alternatively to, visible light. In some embodiments, polarizer films are configured to polarize light having a wavelength in a range from about 700 nm to about 2,000 nm or more. In certain embodiments, polarizer films can polarize light from about 400 nm to about 700 nm. For example, broadband visible polarizer films will generally polarizer light in the 400 nm to 700 nm range.

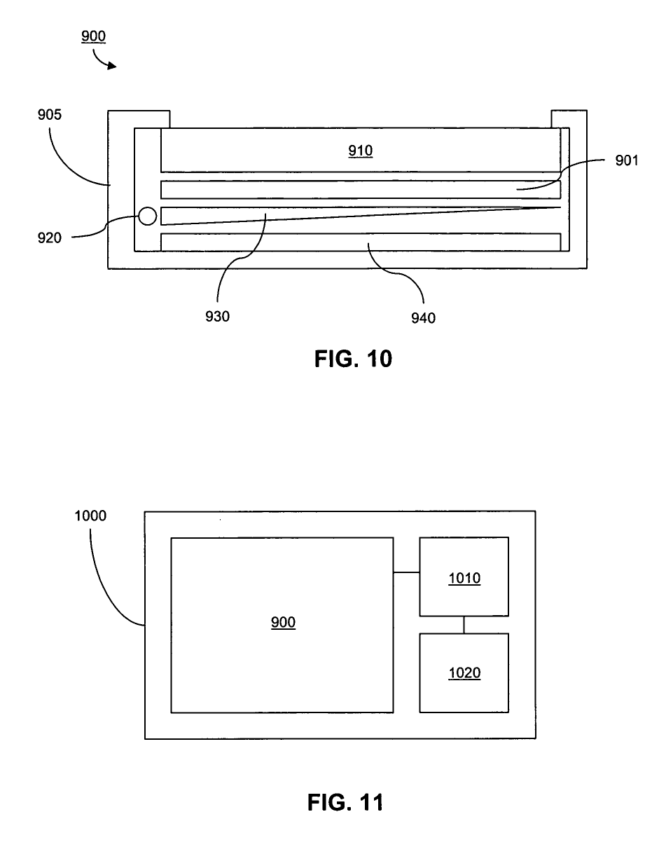

In general, polarizer films can be used in a number of different applications. In many applications, polarizer films are used where a source of light is unpolarized but polarized light is desired. As an example, polarizer films are used in liquid crystal displays (LCDs). Referring to FIG. 10, in certain embodiments, a LCD 900 includes a liquid crystal panel 910, a backlight 920, a light guide 930, a reflective polarizer film 901, and a diffuse reflector 940. LCD 900 includes a housing 905, which encloses and protects panel 910 and the other components. During operation, light guide 930 guides light from back light 920 along its length. This light, which is unpolarized, leaks out of light guide 930 towards panel 910. Reflective polarizer film 901 transmits a portion of the light from light guide 930 and reflects other light back towards the light guide. The transmitted light, now polarized, is incident on panel 910, which includes a number of pixels each capable of transmitting or blocking incident light. Light initially reflected by reflective polarizer film 901 is reflected/scattered by light guide 930, diffuse reflector 940, and/or reflective polarizer film 901 until it is eventually transmitted by the polarizer film or absorbed by a component within housing 905. This recycling of light initially reflected by reflective polarizer film 910 can increase the efficiency and/or brightness of LCD 900 relative to comparable LCD's that do not include polarizer films. Details of the operation of a LCD panels is described by P. Yeh and C. Gu, Optics of Liquid Crystal Displays (John Wiley & Sons, Inc., 1999).

Optionally, LCD 900 can include one or more components, such as one or more sheets of prismatic film (e.g., brightness enhancement film or a turning film) and/or one or more sheets of diffuser film.

LCD 900 is an example of a transmissive LCD. More generally, however, polarizer films can be used in other types of LCD as well. For example, polarizer films can be used in reflective or transflective LCDs. Reflective LCDs use ambient light instead of a backlight, while transflective LCDs include a backlight, but switch between using ambient light and light from the backlight depending on lighting conditions. In either case, polarizer films can be used as a rear polarizer for the display panel, where it reflects block state polarization ambient light transmitted by the other panel components, while blocking block state light from the backlight (in the case of a transflective LCD).

Polarizer films, such as those described herein, can also be used in flexible LCDs. Conventional displays are made using glass substrates and, as a result, are rigid devices. Flexible LCDs, on the other hand, are formed from flexible (e.g. flexible polymer) substrates, and can flex without breaking. Polarizer films formed on flexible substrates can be used as components in flexible displays.

LCD 900 can be used in a variety of display systems, such as, for example, LCD televisions, LCD monitors, and cellular telephones. An example of a display system 1000 is shown schematically in FIG. 11. Here, in addition to LCD 900, display system 1000 includes drive electronics 1010 which provides drive signals to the liquid crystal panel in LCD 900. In certain embodiments, display system 1000 is an LCD television and includes a tuner 1020 that is coupled to drive electronics 1010 and is configured to receive an external signal and provide corresponding image data to drive electronics 1010.

Furthermore, polarizer films can be used in non-LCD applications too. For example, polarizer films can be used to reduce glare in certain applications (e.g., from sunlight or artificial lighting sources). For example, polarizer films can be laminated to windows (e.g., of buildings or cars) in order to reduce glare from sunlight or car headlights. In some embodiments, polarizer films can be used as a component in lighting applications (e.g., as part of a reflective layer for light bulbs, such as fluorescent light bulbs). In still other embodiments, polarizer films can be used a part of a screen for a projection display. For example, reflective polarizer films can be used as a screen for a display that projects polarized light. Applications for such screens include in head-up displays used in vehicles (e.g., in cars or aircraft).

### EXAMPLES

A 150 μm thick roll of polyethylene terephthalate (PET) is unwound to provide a web. Using a blade coating apparatus, and while the web is at room temperature, a layer of a UV-curable resin, ˜200 nm thick, is coated from a solvent onto a surface of the web. The UV-curable resin is composed of 15 wt. % lauryl methacrylate monomer, 65 wt. % ethoxylate bisphenol-A dimethacrylate, 2 wt. % 2,2,2-trifliuoroethyl methacrylate, 10 wt. % diisooctyl phthalate, 3 wt. % darocure 1173, 3 wt. % benzophenone, and 2 wt. % loxiol G70 lubricant. The resin is dissolved in toluene at a concentration of 0.1 wt. %. After the solution is coated, a heater is used to dry up the solvent, leaving the resin layer. The coating is pressed against a cylindrical rotating mold that includes parallel trapezoidal Nickel ridges 150 nm deep. The ridges are uniformly spaced with a period of 145 nm. Adjacent ridges are separated by a groove that is 35 nm at its base and 60 nm wide at its peak. While pressed against the mold, the resin coating conforms to the grooves. UV radiation is directed through a slit-shaped aperture onto one side of the coater's blade to cure the resin while it conforms to the mold. As the web passes the mold, the cured resin releases from the mold surface providing a plurality of parallel trapezoidal ridges of cured resin. The web with the coated and cured resin layer is then rewound and moved to a deposition apparatus.

The deposition apparatus is evacuated down to a pressure of about 8×10⁻⁷ Torr. The roll is then unwound and the transported past an electron beam evaporation apparatus configured to evaporate aluminum onto the ridges. The substrate and evaporation apparatus are arranged so that evaporated aluminum is incident on the web along a direction that is at an angle of 30° with respect to the normal of the plane of the web and perpendicular to the direction along which the ridges extend. The speed of the web and the deposition rate is selected so that the electron beam deposition apparatus would deposit a 40 nm thick aluminum film onto a web with a planar surface. Finally, the coated web is cut into rectangular portions.

The polarizer film has a pass state extinction ratio of more than 50:1 for all wavelengths in a range from 400 nm to 900 nm as measured using an AxoScan™ SpectroPolarimeter made by Axometrics, Inc. (Huntsville, Ala.). The polarizer film also has a transmittance of 25% or more for all wavelengths in a range from 400 nm to 900 nm as measured using the AxoScan™ SpectroPolarimeter.

Other embodiments are in the following claims.

What is claimed is:

1. A method, comprising:
forming a roll of a first material into a substrate; and
forming a plurality of rows of a second material on the substrate,
wherein the second material comprises a metal, the rows of the second material extend along a first direction, the rows are spaced apart from one another, and adjacent rows are spaced apart by about 400 nm or less.

2. The method of claim 1, wherein forming the roll into the substrate comprises unwinding the roll to provide the substrate.

3. The method of claim 1, wherein forming the plurality of rows comprises shaping a surface of the substrate to define a plurality of ridges, wherein the plurality of ridges extend along the first direction.

4. The method of claim 3, wherein the ridges have a triangular cross-sectional profile.

5. The method of claim 3, wherein the plurality of ridges are formed while the surface of the substrate is at a temperature of about 100° C. or more.

6. The method of claim 3, wherein the plurality of ridges are formed while the surface of the substrate is at a temperature of about 200° C. or more.

7. The method of claim 3, wherein the substrate material is a thermoplastic material having a softening temperature, Tₛ, and the plurality of ridges are formed while the substrate is at a temperature equal to or greater than Tₛ.

8. The method of claim 3, wherein forming the plurality of rows of the first material comprises depositing the first material onto the substrate.

9. The method of claim 8, wherein the second material is deposited on the substrate prior to forming the ridges.

10. The method of claim 9, wherein the deposition forms a continuous layer of the second material and the plurality of rows are formed by forming a plurality of discontinuities in the continuous layer, where the discontinuities extend along the first direction.

11. The method of claim 8, wherein the second material is deposited on the substrate after forming the ridges.

12. The method of claim 8, wherein the second material is deposited by evaporating the second material onto the substrate.

13. The method of claim 12, wherein the second material is thermally evaporated.

14. The method of claim 12, wherein the second material is evaporated using an electron beam.

15. The method of claim 8, wherein the second material is deposited by sputtering the second material onto the substrate.

16. The method of claim 8, wherein depositing the second material comprises directing second material towards the substrate along a direction substantially non-normal to a plane of the substrate.

17. The method of claim 2, wherein shaping the surface to define the ridges comprises embossing the surface of the substrate.

18. The method of claim 1, wherein forming the plurality of ridges comprises depositing a layer of a third material on a surface of the substrate and forming the ridges from the layer of the third material.

19. The method of claim 18, wherein forming the plurality of ridges from the layer of the third material comprises molding the third material into the ridges.

20. The method of claim 19, wherein forming the plurality of ridges from the layer of the third material comprises curing the third material.

21. The method of claim 20, wherein the third material is cured by exposing the third material to radiation.

22. The method of claim 21, wherein the radiation is electromagnetic radiation.

23. The method of claim 22, wherein the electromagnetic radiation comprises ultraviolet radiation.

24. The method of claim 22, wherein the radiation is electron beam radiation.

25. The method of claim 17, wherein the ridges have a triangular cross-sectional profile, a trapezoidal profile, or a rectangular profile.

26. The method of claim 1, wherein the first material is a polymer.

27. The method of claim 26, wherein the polymer is a thermoplastic.

28. The method of claim 1, wherein the first material is highly transmissive at a wavelength λ less than about 700 nm.

29. The method of claim 1, wherein the substrate has a thickness of about 500 μm or less.

30. The method of claim 1, wherein the metal is aluminum.

31. The method of claim 1, wherein the metal is silver.

32. The method of claim 1, wherein adjacent rows of second material are spaced apart by about 200 nm or less.

33. The method of claim 1, wherein adjacent rows of second material are spaced apart by about 100 nm or less.

34. The method of claim 1, wherein the rows of second material are arranged to form a grating having a period of about 400 nm or less.

35. The method of claim 1, wherein the rows of second material are arranged to form a grating having a period of about 200 nm or less.

36. The method of claim 1, wherein the rows are arranged so to form a polarizer that transmits about 60% or more of incident light at wavelength λ having a first polarization state and the polarizer blocks about 60% or more of incident light at wavelength λ having a second polarization state orthogonal to the first polarization state, where λ is about 200 nm or more.

37. The method of claim 36, wherein λ is about 2,000 nm or less.

38. The method of claim 36, wherein λ is about 700 nm or less.

39. The method of claim 1, wherein the polarizer transmits about 80% or more of incident light at wavelength λ having the first polarization state.

40. The method of claim 1, wherein the polarizer transmits about 90% or more of incident light at wavelength λ having the first polarization state.

41. The method of claim 1, wherein the polarizer transmits about 95% or more of incident light at wavelength λ having the first polarization state.

42. The method of claim 1, wherein the polarizer blocks about 80% or more of incident light at wavelength λ having the second polarization state.

43. The method of claim 1, wherein the polarizer blocks about 90% or more of incident light at wavelength λ having the second polarization state.

44. The method of claim 1, wherein the polarizer reflects about 60% or more of incident light at wavelength λ having the second polarization state.

45. The method of claim 1, wherein forming the substrate comprises unwinding the roll and the roll is continuously unwound while the plurality of rows are formed on the substrate.

46. The method of claim 1, further comprising forming one or more additional layers on the substrate.

47. The method of claim 1, further comprising cutting the substrate after forming the plurality of rows to provide a polarizer film product.

48. A method, comprising:
forming a roll of a first material into a substrate; and
forming a plurality of rows of a second material on a surface of the substrate,
wherein the rows of the second material extend along a first direction, the rows are spaced apart from one another, and arranged so that the rows form a polarizer that transmits about 60% or more of incident light at wavelength λ having a first polarization state and the polarizer blocks about 60% or more of incident light at wavelength λ having a second polarization state orthogonal to the first polarization state, where is about 700 nm or less.

49. A method, comprising:
forming a plurality of rows of a first material on a surface of a polymer substrate,
wherein the first material comprises a metal, the rows of the first material extend along a first direction, the rows are spaced apart from one another, and adjacent rows are spaced apart by about 400 nm or less.

50. A method, comprising:
forming a plurality of rows of a first material on a surface of a polymer substrate,
wherein the rows of the first material extend along a first direction, the rows are spaced apart from one another, and arranged so that the rows form a polarizer that transmits about 60% or more of incident light at wavelength λ having a first polarization state and the polarizer blocks about 60% or more of incident light at wavelength λ having a second polarization state orthogonal to the first polarization state, where is about 700 nm or less.

51. An article, comprising:
a polymer substrate having a surface including a plurality of ridges that extend along a first direction; and
a plurality of rows of a first material, each row of the first material being supported by a corresponding ridge,
wherein the first material comprises a metal, the rows extend along the first direction, the rows are spaced apart from one another, and adjacent rows are spaced apart by about 400 nm or less.

52. A display, comprising:
a liquid crystal panel;
the article of claim 51; and
a display housing containing the liquid crystal panel and the article.

53. An article, comprising:
a polymer substrate having a surface including a plurality of ridges that extend along a first direction; and
a plurality of rows of a first material, each row of the first material being supported by a corresponding ridge,
wherein the rows extend along the first direction, the rows are spaced apart from one another, and arranged so that the rows form a polarizer that transmits about 60% or more of incident light at wavelength λ having a first polarization state and the polarizer blocks about 60% or more of incident light at wavelength λ having a second polarization state orthogonal to the first polarization state, where is about 700 nm or less.
